(19) United States
(12) Patent Application Publication
(10) Pub. No.: US 2016/0171733 A1
(43) Pub. Date: Jun. 16, 2016

(54) CLIPBOARD FOR ENABLING MASS OPERATIONS ON ENTITIES

(71) Applicants: Oliver Klemenz, Hoffenheim (DE); Uwe Schulz, Walldorf (DE); Veit Spaegele, Leimen (DE)

(72) Inventors: Oliver Klemenz, Hoffenheim (DE); Uwe Schulz, Walldorf (DE); Veit Spaegele, Leimen (DE)

(21) Appl. No.: 14/570,750

(22) Filed: Dec. 15, 2014

(51) Int. Cl. G06T 11/60; G06F 3/0484; G06F 3/0482; G09G 5/377; G09G 5/36

(52) U.S. Cl. CPC G06T 11/60; G09G 5/377; G09G 5/363; G06F 3/0482; G06F 3/04842; G09G 2354/00; G06T 2200/24

(57) ABSTRACT

A system and method for using a clipboard that enables mass operations that identifies a plurality of objects, at least two of the plurality of objects originating from different applications, stores the plurality of objects within a single storage location, executes a function on each of the plurality of objects to produce a plurality of processed objects, the processed objects being accessible from the storage location and respective originating applications, and graphically renders the processed objects.

### FIELD OF INVENTION

The present invention generally relates to information management applications, and more particularly, to information management applications that enable the selection and processing of multiple objects and object instances.

### BACKGROUND

In today's hyper information age, it is not uncommon to manage numerous sources of information. Many existing applications have been developed to manage a single type of information object. For example, some individual applications have been developed to manage e-mail, calendars, tasks, notes, etc. Similarly, some larger applications (e.g., Microsoft Outlook) have been developed to manage multiple object types. Such larger applications typically include search functions so that a user may locate particular information objects, such as a meeting with Joe or an e-mail from Jane. However, both single and multiple object type applications have limited capability to select and process multiple objects and object instances.

Currently user interfaces are generally designed for single object actions. For example, objects are displayed in lists, an object in the list can be selected, and an action can be performed on the selected object. However, existing user interfaces do not function efficiently if executing an action on multiple objects, especially a large number of objects.

In some instances, a multi-selection option is available for tables. However, current multi-selection tools do not easily select multiple instances of an object. In addition, the user interface may not enable the retrieval of certain objects into a single table. As a result, existing multi-selection applications fail to adequately enable a user to capture all of the desired objects.

Accordingly, the inventors have identified a need for improved systems and methods for selecting and processing of multiple objects and object instances. By using the example embodiments described herein, objects may be selected from any application where they can be accessed.

### SUMMARY OF THE INVENTION

Accordingly, the present invention is directed to systems and methods for using a clipboard that enables mass operations on multiple objects and object instances that substantially obviates one or more problems due to limitations and disadvantages of the related art.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the systems and methods for using a clipboard to enable mass operations on multiple objects and object instances include module(s) and/or step(s) for populating the clipboard and executing a mass operation on the objects stored within the clipboard. For example, the systems and methods identify a plurality of objects, at least two of the plurality of objects originating from different applications, store the plurality of objects within a single storage location, execute a function on each of the plurality of objects to produce a plurality of processed objects, the processed objects being accessible from the storage location and respective originating applications, and graphically render the processed objects.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this specification, illustrate embodiments of the disclosure and together with the description serve to explain the principles of the disclosure.

FIG. 1 is a system diagram depicting an architectural overview of a networked system for facilitating mass operations on objects and object instances according to an example embodiment.

FIG. 2 illustrates an example clipboard user-interface according to an example embodiment.

FIG. 3 illustrates a representative view of an example application for use with the clipboard according to an example embodiment.

FIG. 4 is a block diagram showing components of a clipboard application according to an example embodiment.

FIG. 5 illustrates a method for facilitating mass operations on objects and object instances according to an example embodiment.

FIG. 6 illustrates a representative architecture of an electronic device according to an example embodiment.

### DETAILED DESCRIPTION

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the embodiments. Wherever possible, like reference numbers will be used for like elements.

Embodiments of user interfaces and associated methods for using a device are described. In some embodiments, the device is a portable communication device (e.g., a mobile phone or tablet). The user interface may include a touchscreen and/or other input/output devices. It should be understood, however, that the user-interfaces and associated methods may be applied to other devices, such as personal computers and laptops, which may include one or more other physical user-interface devices, such as a keyboard and or mouse.

The portable communication device may support a variety of applications, such as telephone, text messenger, and information management applications. The various applications that may be executed on the device may use at least one common physical user-interface device, such as a touchscreen. One or more functions of the touchscreen as well as corresponding information displayed on the device may be adjusted and/or varied from one application to another and/or within a respective application. In this way, a common physical architecture of the device may support a variety of applications with user-interfaces that are intuitive and transparent. In the discussion that follows, an information management application is used as an example embodiment, but it should be understood that the user-interfaces and associated methods may be applied to a variety of applications.

By applying an information management application according to embodiments of the present disclosure, users will be better equipped to process vast amounts of data, and make more informed decision in real-time. The information management application of the present disclosure avoids data privacy problems by relying on information already available to user. In addition, components of the clipboard used to manage multiple objects may be stored locally or at a remote server.

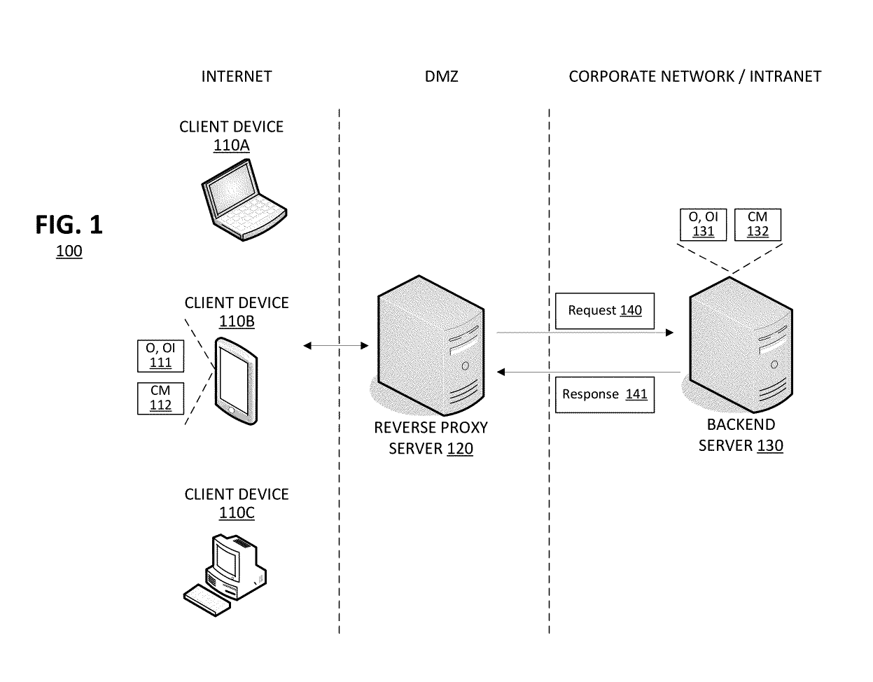

FIG. 1 is a system diagram depicting an architectural overview of a networked system for facilitating mass operations on objects and object instances according to an example embodiment. The example networked system 100 includes client devices 110A, 110B, 110C, reverse proxy server 120, and backend server 130.

One or more client devices, such as client devices 110A, 110B, 110C, may be accessible via an Internet connection, and connected to a reverse proxy server 120 server in a network demilitarized zone (DMZ). Although not shown, the DMZ and/or corporate network may include one or more load-balancing servers. Client devices 110A, 110B, 110C may comprise a variety of devices types which may include, for example, a mobile device (e.g., mobile phone or a smartphone), a personal computer, a laptop, a tablet, or the like. In addition, the various client device types may operate using commercially available operating systems (e.g., Android, iOS, Linux, Windows, etc.). Although not shown, the “client” device may be a server device of another network in some instances.

Each of the client devices 110A, 110B, 110C is configured to transmit and receive respective HyperText Transfer Protocol (HTTP) communications with the backend server 130. The respective HTTP communications may include one or more requests 140 and one or more responses 141. In addition, client devices 110A, 110B, 110C may execute a variety of applications (not shown) that utilize locally and/or remotely-stored objects and object instances, collectively referred to as objects, 111, 131. Each of these applications may be configured to execute one or more operations to process (e.g., analyze, modify, delete, add, etc.) objects 111,131 stored locally or at the backend server 130. By executing the various applications on a client device 110A, 110B, 110C, changes to one or more objects 111,131 may be implemented. Example applications include various SAP® applications, such as Innovation Management, NetWeaver, ByDesign, Suite, Research, Guided Structure Synchronization (GSS), Industry Solutions, and the like etc. The applications may include a variety of components, such as object lists, object inspectors, graphical object displays, and the like.

As alluded to above, example objects and objects instances may include a variety of data objects, such as e-mail messages, calendars entries, task objects, note objects, and the like. In addition, example objects and objects instances further include idea objects, associated object tags, people, sales orders, invoices, and the like. Although example objects are provided, the embodiments are not limited to any particular object type.

The reverse proxy server 120 is configured to transmit communications (e.g., request(s) 140) between a client device 110A, 110B, 110C and an enterprise data system such as a backend server 130 in a corporate intranet/backend network. Similarly, the reverse proxy server 120 may relay communications (e.g., response(s) 141) from the backend server 130 to the appropriate client device 110A, 110B, 110C. For example, changes to an object 111 stored at a client device 110A, 110B, 110C may be relayed to the backend server 130 using a request message 140. In another example, changes to an object 131 stored at the backend server 130 may be relayed to a client device 110A, 110B, 110C using a response message 141.

In some instances, a gateway (not shown) may be disposed between the reverse proxy server 120 and the backend server 130. The optional gateway may translate communications (e.g., request message 140 and response message 141) to and from proprietary protocols, such as remote function call (RFC).

Like the client device 110A, 110B, 110C, backend server 130 may store one or more objects 131. For example, the backend server 130 may store business objects 131 for a plurality of end users and for a plurality of business applications. Lastly, the backend server 130 may be a standalone platform or it may be integrated with other enterprise systems.

Each of the client device 110A, 110B, 110C and the backend server 130 may include one or more clipboard modules 112, 132 for identifying and storing objects 111, 131 identified by an end user. Although depicted at both the client device 110A, 110B, 110C and the backend server 130, the clipboard modules 112,132 may be disposed at either and/or both locations according to the various embodiments.

Clipboard modules 112, 132 enable the end user of various applications to maintain objects and/or related object instances accessible via other applications within a (single) common user-interface and storage location. Here, the user-interface of clipboard modules 112, 132 may be accessible from any of the various applications and/or may be accessible directly as a standalone application of the client device 110A, 110B, 110C. In some instances, the clipboard may be displayed as a side-window that is configured to be displayed (e.g., a slide out window) as desired by an end-user. Thus, an object may be added to the clipboard from various applications while using another application.

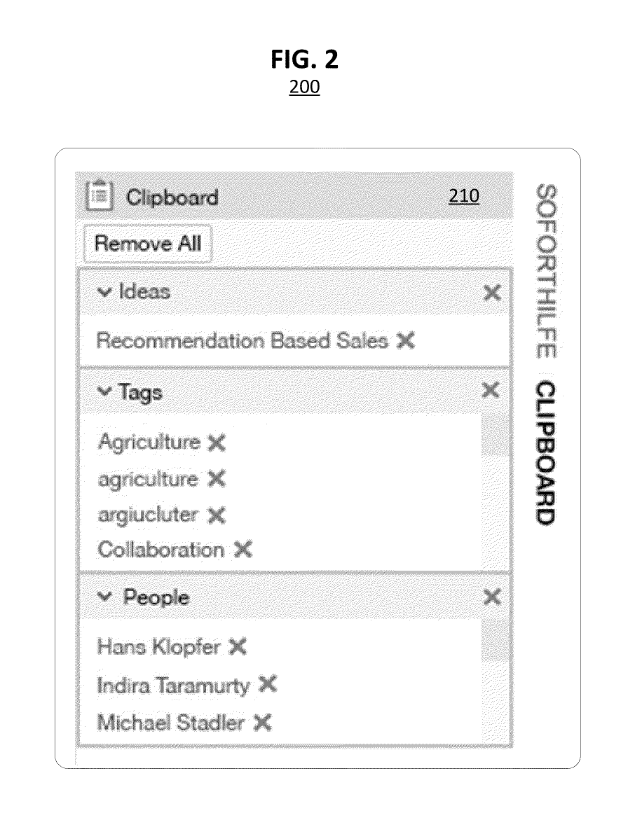

FIG. 2 illustrates an example clipboard user-interface according to an example embodiment. As shown in FIG. 2, the client device 200 may be configured to dynamically generate one or more user-interfaces based upon user selections. For example, if a user selects an object for inclusion in the clipboard, the clipboard modules may link all instances (i.e., from different applications) of the selected object to the user's selection. In addition, if an object is added to the clipboard, a mass process may be executed to each object stored within the clipboard, including linked object instances.

Objects may be added to the clipboard 210 such that a visual representation (e.g., an object name) of the added objects is depicted within the user-interface. Visual representations may include icons, checkboxes, text, navigation links, and the like. The example user-interface depicted in FIG. 2 is displayed as a slide out window using SAP's® UX3 shell. Of course, the embodiments may be implemented using alternative user-interface technologies. For example, SAP® UI5 (i.e., a user interface for HTML5) and other document languages may be used.

In some embodiments, objects may be grouped by object type. For example, object types may include idea, tag, people, e-mails, meetings, sales orders, invoices, etc. Here, if an object is added to the clipboard 210, a mass process may be limited to objects having a particular type (e.g., all objects having a particular tag). Similarly, objects may be removed from the clipboard 210 on a per object type or individual basis.

An object may remain stored within the clipboard for a variety of durations. For example, in a non-persistent mode, the clipboard is not persistent, and therefore is deleted at the end of each session of the clipboard. Thus, the clipboard may be empty for each new session. In another example, a local storage mode may be used. Here, the clipboard may persist in the local storage of the client (e.g., browser session), and be deleted when the client cache is cleared. In the local storage mode, objects are available from any client session on the same client device. In yet another example, the clipboard is stored at the backend server. In a remotely stored clipboard, objects are available from any client session on any client device.

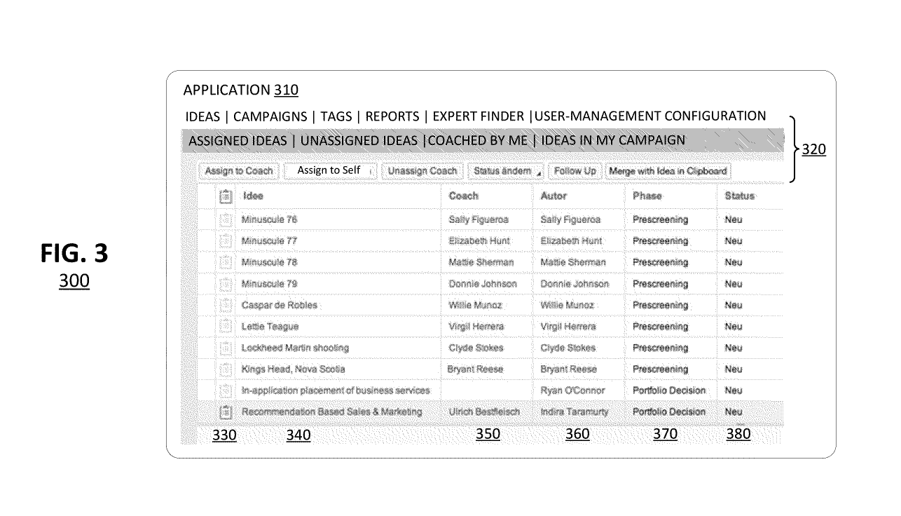

FIG. 3 illustrates a representative view of an example application for use with the clipboard according to an example embodiment.

As shown in FIG. 3, the application 310 includes multiple component sections, such as menus section 320, object selection section 330, object name section 340, object coach section 350, object author section 360, object phase section 370, and object status section 380. Sections 310 and 320 generally incorporate or implement features of an innovation management application for use with the embodiments. Although an innovation management application is depicted as an example business application, the embodiments are not limited to any particular application type.

In the example application 310, the object selection section 330 may include one or more toggle buttons to enable an end user to add, delete, and/or otherwise manipulate an object (e.g., any of the idea objects listed in 340). For example, the toggle buttons in object selection section 330 enable an end user select or deselect objects to/from the clipboard. In other instances, objects may be added, deleted, or otherwise manipulated via keyboard shortcuts of the clipboard (e.g., menus section 320).

Within object selection section 330, the current icon status of a toggle button may identify the current state of a particular object. If an object is added to the clipboard, and the clipboard is not shown, the object and/or its toggle button may be displayed such that the end user may view the effect of adding the object to the clipboard (e.g., highlighted, pressed, and the like). For example, an “active” icon denotes an object has been added to the clipboard, and an “inactive” icon denotes an object that has not been added to the clipboard.

The example application may be linked or integrated with one or more other applications, including e-mail, calendar, file access, document storage, and other applications. Each of the display sections 320-380 may be fully integrated modules of the example application, or may retrieve objects from one or more standalone applications.

Client device 300 may be configured to execute and display one or more user-interfaces of an application 310. The example application 310 may be displayed on a variety of client devices which may include, for example, a mobile device (e.g., mobile phone or a smartphone), a personal computer, a laptop, a tablet, or the like.

The component sections of the example application 310 may be rearranged, resized, added and/or removed by an end user to customize the display of the application. For example, an end user may tap and hold on a desired component section and then drag the component section to move the selected screen to a new location on the display page. In another example, each component section may include a preferences menu. The preferences menu may be invoked by selecting a component section (e.g., right click or a double tap). The example preferences menu may include display configuration and format settings, additional information, options to delete the one or more portions of the display, and other options to modify or control the display.

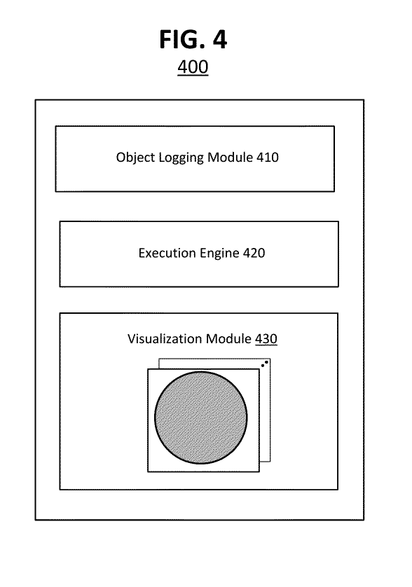

FIG. 4 is a block diagram showing components of the clipboard application according to an example embodiment. As depicted in FIG. 4, clipboard modules 400 include object logging module 410, execution engine 420, and visualization module 430. Although not shown, the object logging module 410 may be coupled to one or more other applications that utilize the objects stored within object logging module 410.

Object logging module 410 stores a variety of data fields related to objects generated within any of applications stored within the client device or backend server. In some instances, it may be desirable to filter and/or remove some objects from object logging module 410. For example, objects of a particular type may be filtered or removed.

Execution engine 420 may instruct one or more applications to execute one or more functions on the objects selected in object logging module 410. In some embodiments, the execution engine 420 may identify or propose suggested functions to execute on selected objects. For example, if the objects stored within the object logging module 410 are idea objects, the execution engine 420 may suggest changing the tag of an idea object (e.g., preliminary tag to under-review tag).

Visualization module 430 of the clipboard modules 400 may generate and display one or more user-interfaces. Each component section of the user-interface may be generated based on data retrieved from the object logging module 410 and execution engine 420. Visualization module 430 may generate one or more pages of the clipboard application to be provided on a display of a host via an Internet browser or a standalone application. Visualization module 430 may implement a variety of display technologies, such as SAP® UX3 or UI5 (i.e., a user interface for HTML5) and other display techniques. More generally, the visualization module 430 may be based on any document language (e.g., markup language) or other-type language for structuring and presenting content to the user. The document language may include HTML, but is not so limited.

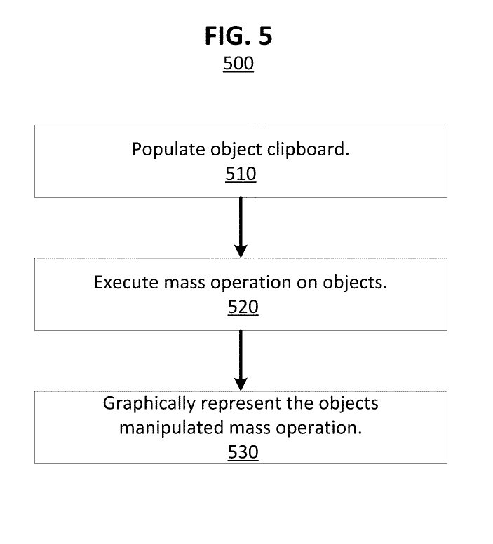

FIG. 5 illustrates a method for facilitating mass operations on objects and object instances according to an example embodiment.

At step 510, an end user may activate the clipboard modules to add one or more objects to the clipboard. Once activated, the object logging module may store a variety objects, object instances, tags, and associated data fields. As the number of objects stored within the clipboard increases, the capabilities of the information management application expand as well.

Next, at step 520, an end user executes a mass operation on the objects. Execution of a mass operation may be initiated from the clipboard itself For example, the end user may select a function to merge each object stored within the clipboard. In another example, the end user may select a function to modify the status, person responsible, and/or another tag for each object stored within the clipboard. In some instances, the execution of a mass operation may only be applied to a predetermined object type.

Alternatively, execution of a mass operation may be initiated from an application. Here, mass operation may be applied to objects stored within the clipboard with reference to a leading object. For example, a mass operation may be initiated from within a list, object inspector, search, graph, and/or other component of the application. If a mass operation is initiated from the application, the mass operation may be applied to all objects stored within the clipboard. Additional functions may be applied to the leading object (e.g., if unifying tags to the leading tag, or if merging ideas to the leading idea, etc.). In some instances, the execution of a mass operation may only be applied to a predetermined object type.

Lastly, at step 530, one or more visualization modules may generate one or more pages of the clipboard application that reflect the changes caused by the mass operation. Visualizations may be based on locally stored information, or information stored at a backend server.

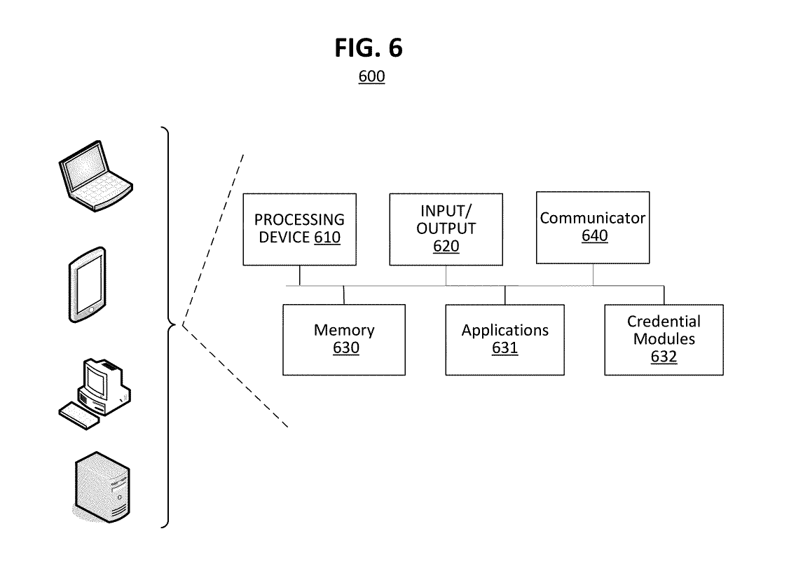

FIG. 6 illustrates a representative architecture of an electronic device according to an example embodiment. Electronic device 600 (e.g., client device or backend server) may include processing device 610, input/output modules 620, memory 630, and communications device 640. Electronic device 600 may further include one or more applications 631, clipboard modules 632, and/or other modules or components that generally implement the functionality of the electronic device 600.

Processing device 610 may execute instructions of clipboard modules 632 and other modules stored in memory 630. Memory 630 may include a computer readable medium storing applications 631 and clipboard modules 632. In an example embodiment, memory 630 may contain different components for retrieving, presenting, changing, and saving data and may include computer readable media. Memory 630 may include a variety of memory devices, for example, Dynamic Random Access Memory (DRAM), Static RAM (SRAM), flash memory, cache memory, and other memory devices. Additionally, for example, memory 630 and processing device(s) 610 may be distributed across several different computers that collectively comprise a system.

Components of electronic device 600, such as processing device 610, memory 630, and communications device 640, may be interconnected via a system bus. In various embodiments, the electronic device 600 may have an architecture with modular hardware and/or software systems that include additional and/or different systems communicating through one or more networks via communications device 640.

Communications device 640 may enable connectivity between the processing devices 610 in the electronic device 600 and other systems by encoding data to be sent from the processing device 610 to another system over a network and decoding data received from another system over the network for the processing device 610.

Processing device 610 may perform computation and control functions of a system and comprises a suitable central processing unit (CPU). Processing device 610 may include a single integrated circuit, such as a micro processing device, or may include any suitable number of integrated circuit devices and/or circuit boards working in cooperation to accomplish the functions of a processing device. Processing device 610 may execute computer programs, such as object-oriented computer programs, within memory 630.

Although example clipboard modules 632 are depicted as a single entity, it is to be appreciated that clipboard modules 632 may include fewer or more modules and components, and may be integrated into a single system from the operation of independent systems and subsystems. For example, the clipboard modules 632 may operate as a standalone service which provides data to the electronic device 600. Further, additional and different modules and other types of integration with the backend server and/or the requesting client device may be provided.

Each of the client devices, the reverse proxy server, gateway, backend server, and other processing components may be embodied, individually or in combination, in a computing device in the form of, for example, a personal computer, a server computer, a mobile computer, or any other suitable computing device. In various embodiments, the computing device may be used to implement computer programs, logic, applications, methods, processes, or software to provide data transformation operations, as described herein. Although mobile client scenarios are illustrated, it will be understood that the applicability of the presently described data transformation techniques and components are not limited to mobile client scenarios. A variety of clients and client types (including combinations of mobile and non-mobile client types) may be used.

With respect to the depicted system configurations depicted, it should be appreciated that in other embodiments, the systems and network configurations may include fewer or more components apart from those shown. For example, in example embodiments, the data services provided in the corporate intranet/backend can be integrated within fewer or additional components. The components and respective modules may be in the form of software that is processed by a processor. In another example, the components and respective modules may be in the form of firmware that is processed by application specific integrated circuits (ASIC), which may be integrated into a circuit board. The components and respective modules also may be in the form of one or more logic blocks included in a programmable logic device (for example, a field programmable gate array). The components and respective modules may be adapted, and/or additional structures may be provided, to provide alternative or additional functionalities beyond those specifically discussed.

It will be apparent to those skilled in the art that various modifications and variations can be made in the systems and methods for using a clipboard that enables mass operations of the present disclosure without departing from the spirit or scope of the disclosure. Thus, it is intended that the present disclosure cover the modifications and variations of this disclosure provided they come within the scope of the appended claims and their equivalents.

We claim:

1. A method comprising:
identifying a plurality of objects, at least two of the plurality of objects originating from different applications;
storing the plurality of objects within a single storage location;
executing a function on each of the plurality of objects to produce a plurality of processed objects, the processed objects being accessible from the storage location and respective originating applications; and
graphically rendering the processed objects.

2. The method according to claim 1, wherein at least two of the plurality of objects merge to produce the plurality of processed objects.

3. The method according to claim 1, wherein a tag associated with each of the plurality of objects is changed to produce the plurality of processed objects.

4. The method according to claim 1, further comprising suggesting a function to execute on each of the plurality of objects.

5. The method according to claim 1, wherein the function is launched from one of the applications.

6. The method according to claim 1, wherein the function is launched from a user-interface of the storage location.

7. A non-transitory computer readable storage medium storing one or more programs configured to be executed by a processor, the one or more programs comprising instructions for:
identifying a plurality of objects, at least two of the plurality of objects originating from different applications;
storing the plurality of objects within a single storage location;
executing a function on each of the plurality of objects to produce a plurality of processed objects, the processed objects being accessible from the storage location and respective originating applications; and
graphically rendering the processed objects.

8. The computer readable storage medium of claim 7, wherein at least two of the plurality of objects merge to produce the plurality of processed objects.

9. The computer readable storage medium of claim 7, wherein a tag associated with each of the plurality of objects is changed to produce the plurality of processed objects.

10. The computer readable storage medium of claim 7, further comprising instructions for suggesting a function to execute on each of the plurality of objects.

11. The computer readable storage medium of claim 7, wherein the function is launched from one of the applications.

12. The computer readable storage medium of claim 7, wherein the function is launched from a user-interface of the storage location.

13. An electronic device comprising:
one or more processors; and
memory storing one or more programs for execution by the one or more processors, the one or more programs including instructions for:
identifying a plurality of objects, at least two of the plurality of objects originating from different applications;
storing the plurality of objects within a single storage location;
executing a function on each of the plurality of objects to produce a plurality of processed objects, the processed objects being accessible from the storage location and respective originating applications; and
graphically rendering the processed objects.

14. The electronic device according to claim 13, wherein at least two of the plurality of objects merge to produce the plurality of processed objects.

15. The electronic device according to claim 13, wherein a tag associated with each of the plurality of objects is changed to produce the plurality of processed objects.

16. The electronic device according to claim 13, further comprising instructions for suggesting a function to execute on each of the plurality of objects.

17. The electronic device according to claim 13, wherein the function is launched from one of the applications.

18. The electronic device according to claim 13, wherein the function is launched from a user-interface of the storage location.
